(19) United States
(12) Patent Application Publication
(10) Pub. No.: US 2015/0118399 A1
(43) Pub. Date: Apr. 30, 2015

(54) LEAD-FREE AND SULPHURIC ACID-FREE METHOD FOR GALVANISING METALLIC MATERIALS, AND STEARATE-REMOVING COMPOSITION

(71) Applicant: OXIPRANA INDÚSTRIA QUÍMICAL LTDA, Prazeres, Jaboatão dos Guararapes (BR)

(72) Inventor: Luiz Guerra Galvão Filho, Jaboatao dos Guararapes (BR)

(73) Assignee: OXIPRANA INDUSTRIA QUIMICA LTDA, Prazeres, Jaboatao dos Guararapes (BR)

(21) Appl. No.: 14/399,561

(22) PCT Filed: May 7, 2013
(86) PCT No.: PCT/BR2013/000152

§ 371 Date: Nov. 7, 2014

(30) Foreign Application Priority Data
May 8, 2012 (BR) BR1020120108526

(51) Int. Cl. C23C 2/02; C11D 11/00; A46B 7/06; C11D 7/06; C11D 7/26; C23C 2/38; C11D 7/36

(52) U.S. Cl. CPC C23C 2/02; C23C 2/38; C11D 11/0029; C11D 7/36; C11D 7/06; C11D 7/265; C11D 7/261; A46B 7/06
USPC 427/309; 427/329; 510/272; 401/196; 401/268

(57) ABSTRACT

The present invention relates to a galvanization process that comprises a residue cleanup step which aims to provide many improvements and facilities to manufacturers and processors of metal wires in general.

The process of this invention removes the use of lead of the conventional wire cleaning process for galvanization and incorporates a step with a stearate removing composition which maximizes the galvanization efficiency and reduces lead acquisition and energy costs to heat said lead, and avoids handling of lead and oxide formed on its surface. Thus, the process of this invention makes the environment less insalubrious and reduces the impact of this activity on the environment.

### FIELD OF THE INVENTION

The present invention relates to a process of cleaning residues and galvanization, particularly in relation to coating metallurgy, and treatment of metallic materials with metallic materials, which takes place by means of galvanization of wires and similar products, from the elimination of the use of cast lead, as applied in the conventional cleaning process for galvanizing wires.

The present invention adds a distinctive element in the so-called etching bath, in order to maximize the efficiency of galvanization and reduce the costs related to lead acquisition and energy for heating said lead, besides of avoiding handling the lead and the oxide formed on its surface. Thus, the process of this invention makes the environment less insalubrious and reduces the impact of this activity on the environment.

### BACKGROUND OF THE INVENTION

It is broadly known that the use of cast lead in galvanization processes may seriously affect the professionals involved in such processes due to lead exposure, and may additionally cause serious environmental problems.

In tanks of cast lead used in galvanization, particularly on its surface, an oxide layer is formed and must be periodically removed from the tank. This procedure is carried out with large perforated paddles operated by a professional duly equipped and using a disposable mask, since the dimensions of the lead particles is greater than five microns.

As is commonly known by the persons skilled in the galvanization art, particularly in the galvanization processes of wires and other similar metal materials, the process for obtaining galvanized wire is as follows: firstly, the wire undergoes a diameter reduction in a drawing process, where a lubricant soap is used, so that the wire properly slides and is obtained at the required diameter.

Subsequently, this wire is immersed in a pot with cast lead at a temperature above 400° C., with the intrinsic purpose of burning the residues of said lubricant soap, so that it can then be immersed in a stripper tank based on hydrochloric acid (HCl), to promote the removal of the charred residue of soap and small oxidations.

Then, the wire is rinsed in a tank with water to remove the excess of acid and other residues from the etching process.

Afterwards, the wire is submitted to a flow bath, which consists of a water-based solution basically comprised by zinc chloride and ammonium chloride wherein, for this phase of the process, there are still other materials that may be added.

In the following step, the wire is immersed in a pot of molten zinc at a temperature varying between 440 and 550° C., where the zinc adheres to the wire through a process already broadly known and adopted by most of wire manufacturers.

This prior art process of cleaning wire to galvanization is not efficient in an adequate and substantial manner, and additionally presents environmental and insalubrity issues resulting from its use.

Human contact with lead, when exposed at high concentrations, can cause disorders in almost all parts of the body, such as the central nervous system, blood and kidneys, culminating in death.

Unlike acute poisoning, which usually has a easily detectable source, prolonged exposure to lead occurs through multiple sources, such as oil, industrial processes, paints, welds in canned articles, water pipes, air, dust, street and road dust, soil, water and food.

At low doses, exposure to lead changes hemoglobin production (a molecule present in red blood cells, responsible for binding these cells to oxygen) and biochemical brain processes. Thus, exposure to lead causes psychological and behavioral changes, such as impaired cognitive ability.

Additionally, the prior art process of cleaning wire does not perform a full cleaning, and some residues remain attached to the wire consequently causing failures in wire galvanization that lead to the discard of defective parts of galvanized wire, which are discarded as offscourings or, in other cases, return to the beginning of the process for withdrawing the galvanized material and performing a new cleaning cycle, thus impairing the production and increasing costs.

The present invention takes advantage of a distinctive element in the wire drawing soap saponification bath that maximizes galvanization efficiency and avoids manipulation of lead and oxide formed on its surface. Thus, the process of this invention makes the environment less insalubrious and reduces the impact of this activity on the environment.

### DETAILED DESCRIPTION OF THE INVENTION

The present invention aims to solve the problems presented by the wire galvanization processes of the state of the art and provides a process for cleaning residues and galvanizing metal materials like drawn wires and the like with increased production of galvanized wire and greater effectiveness in material cleaning.

Unlike the wire galvanization processes of the state of the art, the process of this invention uses a composition to remove stearates instead of a lead pot used in the state of the art wire galvanization processes. Said lead pot elimination maximizes the galvanization efficiency, reduces costs related to raw materials and energy and makes the galvanization environment more salubrious and protected for the professionals that work at this point and for the environment.

Differently of the prior art wire galvanization processes, the process of this invention uses a sponge set made from synthetic fibers, natural fibers or rotating brushes. When said synthetic fibers, natural fibers or rotating brushes are placed in tanks of the stearate removing composition and rinse, they promote cleaning of the wire material to be galvanized.

The other steps of the galvanization process, which are carried out as from said cleaning step, remain unchanged. Thus, the galvanization process continues with the steps of rinsing, etching (optional) and flushing, drying (optional) and soaking of the material in the zinc pot, thus completing the galvanization process.

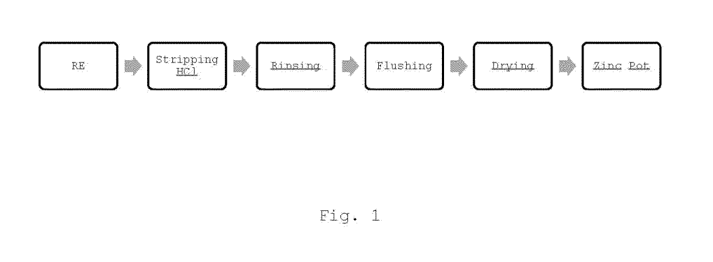

The present invention will now be described with reference to the non-restrictive chart of FIG. 1, which illustrates the invention in terms of the steps of the new wire galvanization process.

### DETAILED DESCRIPTION OF THE INVENTION

The present invention relates to a galvanization process with residue cleanup (1) which aims to provide improvements and advantages for manufacturers and processors of metal wires (A), characterized in that it comprises a residue cleanup process (1) that takes place during galvanization (7) of wires (A) and related articles, and which it is based on the elimination of the lead pot used in the conventional process that adds a lubricant soap (SL) to the etching bath (3), in order to maximize the galvanization efficiency (7), reduce costs related to energy and raw materials and to make the galvanization environment healthier and protected to professionals that work at this point and to the environment.

Thus, the process of the instant invention (1) differs from the state of the art processes by the fact that it incorporates a stearate removing composition, instead of using a lead pot bath step, which is the first stage after drawing (T) with lubricant soap (SL), this step aiming to remove any residues from the lubricant soap (SL).

Unlike the cast lead pot bath step of the state of the art, the use of stearate removing compositions, according to the present invention, provides the required efficiency for removing lubricant soap (SL) residues.

Thus, said wire is immersed in the stearate removing composition according to the present invention, which may remove lubricant soap residues (of stearates) and provide the flow necessary to prepare iron to absorb the zinc from galvanization.

The stearate removing composition, according to the present invention, comprises the following formula:

| | |
|---|---|
| Diphosphonic hydroxyethylene acid | 1-15% |
| Potassium hydroxide | 20-40%, |
| Oleic acid | 1-10%, |
| Propylene glycol | 1-20%, |
| Butyl glycol | 1-10% and |
| Silicone antifoam | 0.5-3%. |

The stearate removing composition according to the present invention is not normally used in its concentrated range, being preferentially used at a concentration between 8 and 30%.

The working temperature of the stearate removing composition, in this step of the process of the present invention, lies between 25 and 100° C.

Thus, the process of this invention comprises a removing step (RE) which may remove all and any residue of lubricant soap (SL) material, without the need for a bath in the lead pot.

As mentioned above, another innovative element of this invention is the incorporation of a sponge set (E), comprised by synthetic fibers, natural fibers or rotating brushes in the removing and rinsing tanks, through which the wire (A) to be galvanized passes.

Said sponge set (E) is conformed and positioned in a manner to wrap the entire wire surface (A), to the extent that this wire (A) moves in the direction of the rinsing water tank, of the next step of the galvanization process. Thus, the sponge set (E) promotes the cleaning of the wire to be galvanized (A) through mechanical action.

As previously mentioned, the subsequent steps of the galvanization process, namely the rinsing (4), etching (optional) and flushing (5) steps, the optional drying step (6) and the immersion of the material in the zinc pot (7) complete the hot dip galvanizing process.

The persons skilled in the art will recognize, or will be able to determine, using no more than routine experimentation, many equivalents of the invention, as described herein. The present invention may comprise other embodiments and can be carried out or performed in a variety of ways. Equivalents of the invention are intended to be covered by the claims below. It should be understood that the terminology used herein is intended to describe the invention, without limiting the same.

1. Process for residue cleanup and galvanization of drawn wire metal materials which eliminates a lead pot bath step, characterized in that it comprises the steps of:
drawing the wire with lubricant soap;
bathing the drawn wire in a removing bath with a stearate removing composition to remove residues, followed by a sponge set which is made with synthetic fibers, natural fibers or rotating brushes, placed in a strategic position in a removing tank through which the wire to be galvanized passes;
rinsing in a tank with water;
optionally etching;
flushing; and
immersing in a pot with molten zinc, thus finishing the hot dip galvanizing process.

2. Process, according to claim 1, characterized in that the removing bath comprises 1 to 15% of diphosphonic hydroxyethylene acid, 20 to 40% of potassium hydroxide, 1 to 10% of oleic acid, 1 to 20% of propylene glycol, 1 to 10% of butyl glycol and 0.5 to 3% of silicone antifoam.

3. Process, according to claim 2, characterized in that the removing bath is used at a final concentration from 8 to 30%, at a working temperature between 25 and 100° C.

4. Process, according to claim 1, characterized in that the sponge set, made from synthetic fibers, natural fibers or rotating brushes, is conformed and positioned in such a way to wrap the entire wire surface.

5. Process, according to claim 1, characterized in that the flushing step comprises a water bath, zinc chloride and ammonium chloride.

6. Process, according to claim 1, characterized in that it comprises an oven drying step, occurring between the flushing step and the zinc application step.

7. Process, according to claim 1, characterized in that the zinc is melted and adheres to the steel wire at a temperature which varies between 440 and 550° C.

8. Stearate removing composition characterized in that it comprises 1 to 15% of diphosphonic hydroxyethylene acid, 20 to 40% of potassium hydroxide, 1 to 10% of oleic acid, 1 to 20% of propylene glycol, 1 to 10% of butyl glycol and 0.5 to 3% of silicone antifoam.

9. Composition, according to claim 8, characterized in that it further comprises a solvent, diluent, preservative or adjuvant.

10. Composition, according to claim 8, characterized in that it is accompanied with a sponge set or rotating brushes which comprises synthetic fibers or natural fibers.
